(19) United States
(12) Patent Application Publication
(10) Pub. No.: US 2020/0309991 A1
(43) Pub. Date: Oct. 1, 2020

(54) TOPOLOGICALLY CORRECT HORIZONS FOR COMPLEX FAULT NETWORK

(71) Applicant: Landmark Graphics Corporation, Houston, TX (US)

(72) Inventors: Andrzej Czeslaw Szymczak, Highlands Ranch, CO (US); Wei Li, Houston, TX (US); Donald Douglas Nelson, Highlands Ranch, CO (US)

(73) Assignee: Landmark Graphics Corporation, Houston, TX (US)

(21) Appl. No.: 16/091,481

(22) PCT Filed: Sep. 11, 2017
(86) PCT No.: PCT/US2017/050990

§ 371 Date: Oct. 4, 2018

(51) Int. Cl. G01V 99/00; G06T 17/05; G06T 7/50; G06Q 10/04

(52) U.S. Cl. CPC G01V 99/005; G06T 17/05; G06T 7/50; G06T 2207/30184; G01V 2210/642; G01V 2210/641; G06Q 10/04

(57) ABSTRACT

A method and a system for modeling a three-dimensional geological structure. A method may comprise selecting input data from well measurement systems, seismic surveys or other sources, inputting the input data into an information handling system, building a quotient space, projecting constraints to the quotient space, constructing depth functions on the quotient space, trimming against a fault network, and producing a three-dimensional model of horizons. A system may comprise a downhole tool. The downhole tool may comprise at least one receiver and at least one transmitter. The system may further comprise a conveyance and an information handling system. The information handling system may be configured to select an input data, build a quotient space, project constraints to the quotient space, construct depth functions on the quotient space, trim against a fault network, and produce a three-dimensional model of a geological structure.

### BACKGROUND

For oil and gas exploration and production, determining a three-dimensional model of subsurface structures such as faults and horizons may be beneficial in planning the placement and operation of well installations. For example, a well installation and operation may comprise, in part, lowering multiple sections of metal pipe (i.e., a casing string) into a wellbore, and cementing the casing string in place. In some well installations, multiple casing strings are employed (e.g., a concentric multi-string arrangement) to allow for different operations related to well completion, production, or enhanced oil recovery (EOR) options. These operations may be time consuming and costly.

Reducing the cost and time associated with well installations is an ongoing issue. Efforts to mitigate cost may comprise determining the three-dimensional model of faults and horizons below the earth's surface. Such a model may be used to determine the three-dimensional distribution of rock properties such as porosity and permeability. This information may allow operators to place well installation and install casing string in the fewest areas to recover the largest amount of formation fluids possible.

### BRIEF DESCRIPTION OF THE DRAWINGS

These drawings illustrate certain aspects of some examples of the present disclosure, and should not be used to limit or define the disclosure.

FIG. 1 illustrates an example of a well measurement system;

FIG. 2 illustrates an example of a drilling system;

FIG. 3 illustrates a flow chart for creating a three-dimensional model of geological structure;

FIG. 4 illustrates a flow chart for implementing steps within an information handling system;

FIG. 5 illustrated the process of building a quotient space;

FIG. 6 illustrates the quotient space;

FIG. 7 illustrates z-sets of points of the quotient space;

FIG. 8 illustrates a concept of the boundary surface for a fault network;

FIG. 9 illustrates an embedded quotient space;

FIG. 10 illustrates a step of trimming the quotient space against the fault network;

FIG. 11 illustrates a base grid, pillars and volumes, entities needed in construction of a discretized quotient space;

FIG. 12 illustrates cells of the discretized quotient space;

FIG. 13 illustrates the discretized quotient space;

FIG. 14 illustrates projection onto the discretized quotient space;

FIG. 15 illustrates embedding of quotient space in the three-dimensional space;

FIG. 16 illustrates trimming against the fault network for a discretized quotient space;

FIG. 17 illustrates how fault extensions split volumes;

FIG. 18 illustrates key concepts related to construction of fault extension curves;

FIG. 19 illustrates the embedding of the quotient space constructed with fault extensions;

FIG. 20 illustrates trimming of the quotient space constructed with fault extensions;

FIG. 21A compares the result for a synthetic fault network without fault extensions;

FIG. 21B compares the result for a synthetic fault network with fault extensions;

FIG. 22A illustrates an example of how fault extensions may be implanted using test surfaces;

FIG. 22B illustrates another example of how fault extensions may be implanted using test surfaces;

FIG. 22C illustrates another example of how fault extensions may be implanted using test surfaces;

FIG. 23 illustrates an example of a three-dimensional geographical model.

### DETAILED DESCRIPTION

This disclosure may generally relate to methods for creating a three-dimensional model of a geological structure. Specifically, data recorded at the surface from downhole tools or data obtained from seismic surveys may provide data points for mapping a geological structure. Three-dimensional computer models of geological structures may be used by the energy industry to locate hydrocarbons beneath the earth's surface and optimize their extraction.

In order to be widely applicable, an information handling system used to produce a three dimensional model of geological structure should be able to handle a variety of geologic structures, such as different types of faults (normal, reverse, thrust and strike-slip) and layers of sedimentary or volcanic rocks with arbitrary geometry. Layers of rock are commonly modeled using horizons, which may be defined as surfaces approximating an infinitesimally thin geologic layer, or interfaces between layers. Geologic formations may be identified as volumes of rock enclosed by horizons and faults. Topological correctness of horizon makes this process simpler, more efficient and more reliable. For example, if horizons have holes or do not fully extend to meet the faults, geologic formations may be determined incorrectly, which may lead to suboptimal well placement, incorrect estimates of oil reserves and may adversely impact the economics of hydrocarbon extraction.

In contrast to most competing approaches that guarantee topological correctness, it is not based on a three-dimensional grid, which makes it efficient and less memory intensive. At the same time, it may accept any fault network with as the input. This makes the modeling process simpler for operators. In particular, faults may be modeled separately before an algorithm may be used to build faulted surfaces, with no geometric constraints or additional information required.

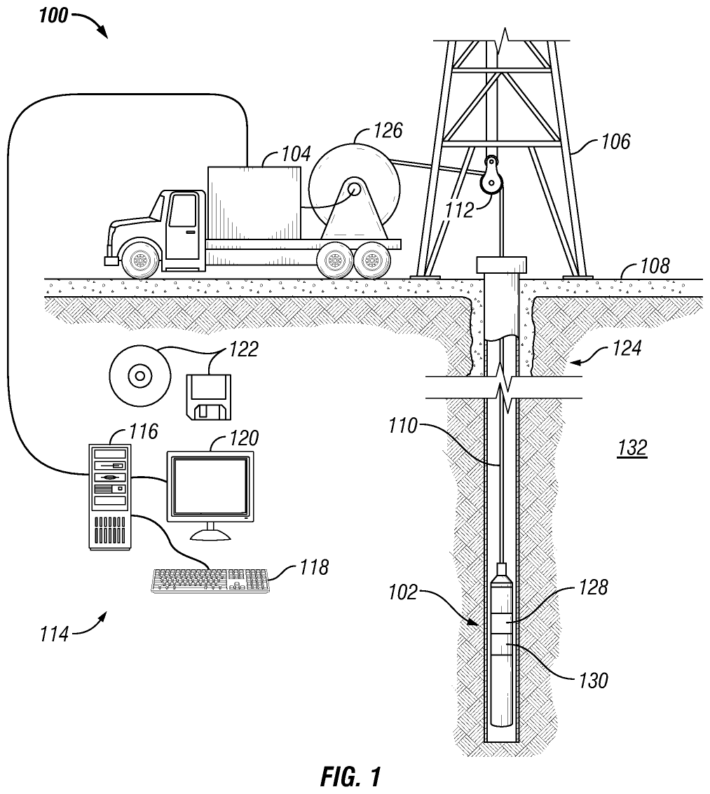

FIG. 1 illustrates a cross-sectional view of a well measurement system 100. As illustrated, well measurement system 100 may comprise downhole tool 102 attached a vehicle 104. In examples, it should be noted that downhole tool 102 may not be attached to a vehicle 104. Downhole tool 102 may be supported by rig 106 at surface 108. Downhole tool 102 may be tethered to vehicle 104 through conveyance 110. Conveyance 110 may be disposed around one or more sheave wheels 112 to vehicle 104. Conveyance 110 may include any suitable means for providing mechanical conveyance for downhole tool 102, including, but not limited to, wireline, slickline, coiled tubing, pipe, drill pipe, downhole tractor, or the like. In some embodiments, conveyance 110 may provide mechanical suspension, as well as electrical connectivity, for downhole tool 102. Conveyance 110 may comprise, in some instances, a plurality of electrical conductors extending from vehicle 104. Conveyance 110 may comprise an inner core of seven electrical conductors covered by an insulating wrap. An inner and outer steel armor sheath may be wrapped in a helix in opposite directions around the conductors. The electrical conductors may be used for communicating power and telemetry between vehicle 104 and downhole tool 102. Information from downhole tool 102 may be gathered and/or processed by information handling system 114. For example, signals recorded by downhole tool 102 may be stored on memory and then processed by downhole tool 102. The processing may be performed real-time during data acquisition or after recovery of downhole tool 102. Processing may alternatively occur downhole or may occur both downhole and at surface. In some embodiments, signals recorded by downhole tool 102 may be conducted to information handling system 114 by way of conveyance 110. Information handling system 114 may process the signals, and the information contained therein may be displayed for an operator to observe and stored for future processing and reference. Information handling system 114 may also contain an apparatus for supplying control signals and power to downhole tool 102.

Systems and methods of the present disclosure may be implemented, at least in part, with information handling system 114. While shown at surface 108, information handling system 114 may also be located at another location, such as remote from borehole 124. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may be a personal computer 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as a keyboard 118, a mouse, and a video display 120. Information handling system 114 may also include one or more buses operable to transmit communications between the various hardware components. Furthermore, video display 120 may provide an image to a user based on activities performed by personal computer 116. For example, producing images of geological structures created from recorded signals. By way of example, a three-dimensional model of the subsurface structure

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

In examples, rig 106 includes a load cell (not shown) which may determine the amount of pull on conveyance 110 at the surface of borehole 124. Information handling system 114 may comprise a safety valve (not illustrated) which controls the hydraulic pressure that drives drum 126 on vehicle 104 which may reels up and/or release conveyance 110 which may move downhole tool 102 up and/or down borehole 124. The safety valve may be adjusted to a pressure such that drum 126 may only impart a small amount of tension to conveyance 110 over and above the tension necessary to retrieve conveyance 110 and/or downhole tool 102 from borehole 124. The safety valve is typically set a few hundred pounds above the amount of desired safe pull on conveyance 110 such that once that limit is exceeded; further pull on conveyance 110 may be prevented.

Downhole tool 102 may comprise a transmitter 128 and/or a receiver 130. In examples, downhole tool 102 may operate with additional equipment (not illustrated, i.e. shakers and equipment for producing shots) on surface 108 and/or disposed in a separate well measurement system (not illustrated) to record measurements and/or values from formation 132. During operations, transmitter 128 may broadcast a signal from downhole tool 102. Transmitter 128 may be connected to information handling system 114, which may further control the operation of transmitter 128. Additionally, receiver 130 may measure and/or record signals broadcasted from transmitter 128. In examples, receiver 130 may measure and/or record signals from additional equipment (not illustrated, i.e. shakers and equipment for producing shots) on surface 108 and/or disposed in a separate well measurement system (not illustrated). Receiver 130 may transfer recorded information to information handling system 114. Information handling system 114 may control the operation of receiver 130. For example, the broadcasted signal from transmitter 128 may be reflected by formation 132. The reflected signal may be recorded by receiver 130. The recorded signal may be transferred to information handling system 114 for further processing. In examples, there may be any suitable number of transmitters 128 and/or receivers 130, which may be controlled by information handling system 114. Information and/or measurements may be processed further by information handling system 114 to determine properties of borehole 124, fluids, and/or formation 132.

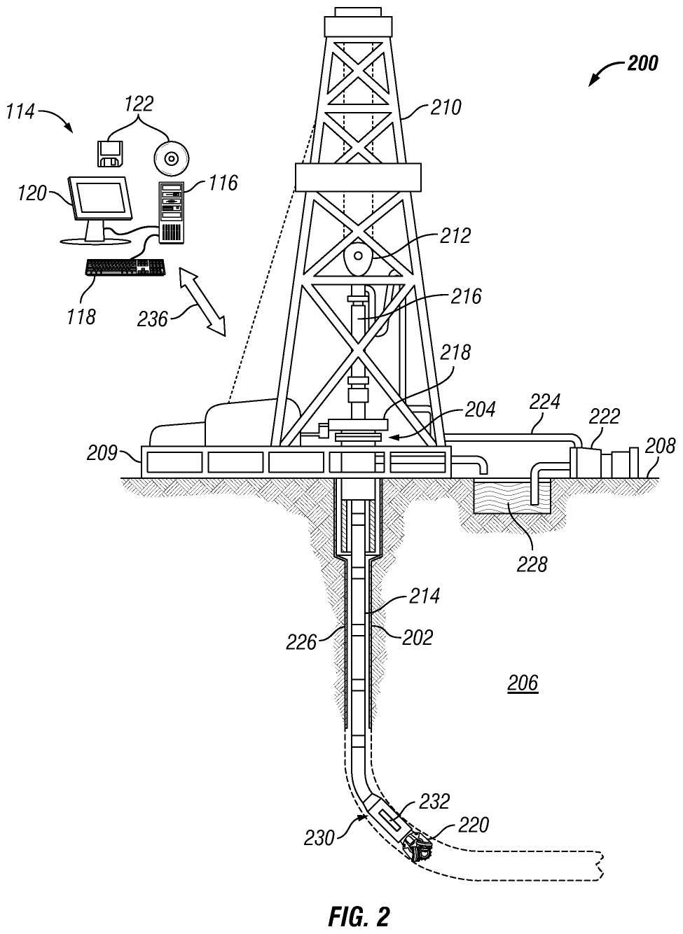

As discussed below, methods may be utilized by information handling system 114 to produce two or three-dimensional models of a subsurface structure, such as formation 132. An image may generated that includes the two or three-dimensional models of the subsurface structure. These models may be used for well planning, (i.e. to design a desired path of borehole 124 (Referring to FIG. 1)). Additionally, they may be used for planning the placement of drilling systems within a prescribed area. This may allow for the most efficient drilling operations to reach a subsurface structure. During drilling operations, measurements taken within borehole 124 may be used to adjust the geometry of borehole 124 in real time to reach a geological target. Measurements collected from borehole 124 may also be used to refine a two or three-dimensional model of a subsurface structure, discussed below. FIG. 2 illustrates a drilling system 200. As illustrated, wellbore 202 may extend from a wellhead 204 into a subterranean formation 206 from a surface 208. Generally, wellbore 202 may include horizontal, vertical, slanted, curved, and other types of wellbore geometries and orientations. Wellbore 202 may be cased or uncased. In examples, wellbore 202 and may include a metallic material. By way of example, the metallic member may be a casing, liner, tubing, or other elongated steel tubular disposed in wellbore 202.

As illustrated, wellbore 202 may extend through subterranean formation 206. As illustrated in FIG. 2, wellbore 202 may extending generally vertically into the subterranean formation 206, however wellbore 202 may extend at an angle through subterranean formation 206, such as horizontal and slanted wellbores. For example, although FIG. 2 illustrates a vertical or low inclination angle well, high inclination angle or horizontal placement of the well and equipment may be possible. It should further be noted that while FIG. 1 generally depicts a land-based operation, those skilled in the art may recognize that the principles described herein are equally applicable to subsea operations that employ floating or sea-based platforms and rigs, without departing from the scope of the disclosure.

As illustrated, a drilling platform 209 may support a derrick 210 having a traveling block 212 for raising and lowering drill string 214. Drill string 214 may include, but is not limited to, drill pipe and coiled tubing, as generally known to those skilled in the art. A kelly 216 may support drill string 214 as it may be lowered through a rotary table 218. A drill bit 220 may be attached to the distal end of drill string 214 and may be driven either by a downhole motor and/or via rotation of drill string 214 from surface 208. Without limitation, drill bit 220 may include, roller cone bits, PDC bits, natural diamond bits, any hole openers, reamers, coring bits, and the like. As drill bit 220 rotates, it may create and extend wellbore 202 that penetrates various subterranean formations 206. A pump 222 may circulate drilling fluid through a feed pipe 224 to kelly 216, downhole through interior of drill string 214, through orifices in drill bit 220, back to surface 208 via annulus 226 surrounding drill string 214, and into a retention pit 228.

With continued reference to FIG. 2, drill string 214 may begin at wellhead 204 and may traverse wellbore 202. Drill bit 220 may be attached to a distal end of drill string 214 and may be driven, for example, either by a downhole motor and/or via rotation of drill string 214 from surface 208. Drill bit 220 may be a part of bottom hole assembly 230 at distal end of drill string 214. Bottom hole assembly 230 may further include a dielectric tool 232, wherein dielectric tool 232 comprises a tool body. As will be appreciated by those of ordinary skill in the art, bottom hole assembly 230 may be a measurement-while drilling (MWD) or logging-while-drilling (LWD) system.

Without limitation, bottom hole assembly 230 may be connected to and/or controlled by information handling system 114, which may be disposed on surface 208. Without limitation, information handling system 114 may be disposed down hole in bottom hole assembly 230. Processing of information recorded may occur down hole and/or on surface 208. Processing occurring downhole may be transmitted to surface 208 to be recorded, observed, and/or further analyzed. Additionally, information recorded on information handling system 114 that may be disposed down hole may be stored until bottom hole assembly 230 may be brought to surface 208. In examples, information handling system 114 may communicate with bottom hole assembly 230 through a communication line (not illustrated) disposed in (or on) drill string 214. In examples, wireless communication may be used to transmit information back and forth between information handling system 114 and bottom hole assembly 230. Information handling system 114 may transmit information to bottom hole assembly 230 and may receive as well as process information recorded by bottom hole assembly 230. In examples, a downhole information handling system (not illustrated) may include, without limitation, a microprocessor or other suitable circuitry, for estimating, receiving and processing signals from bottom hole assembly 230. Downhole information handling system (not illustrated) may further include additional components, such as memory, input/output devices, interfaces, and the like. In examples, while not illustrated, bottom hole assembly 230 may include one or more additional components, such as analog-to-digital converter, filter and amplifier, among others, that may be used to process the measurements of bottom hole assembly 230 before they may be transmitted to surface 208. Alternatively, raw measurements from bottom hole assembly 230 may be transmitted to surface 208.

Any suitable technique may be used for transmitting signals from bottom hole assembly 230 to surface 208, including, but not limited to, wired pipe telemetry, mud-pulse telemetry, acoustic telemetry, and electromagnetic telemetry. While not illustrated, bottom hole assembly 230 may include a telemetry subassembly that may transmit telemetry data to surface 208. Without limitation, an electromagnetic source in the telemetry subassembly may be operable to generate pressure pulses in the drilling fluid that propagate along the fluid stream to surface 208. At surface 208, pressure transducers (not shown) may convert the pressure signal into electrical signals for a digitizer (not illustrated). The digitizer may supply a digital form of the telemetry signals to information handling system 114 via a communication link 236, which may be a wired or wireless link. The telemetry data may be analyzed and processed by information handling system 114.

As illustrated, communication link 236 (which may be wired or wireless, for example) may be provided that may transmit data from bottom hole assembly 230 to an information handling system 114 at surface 108. Information handling system 134 may include a personal computer 116, a video display 120, an keyboard 118 (i.e., other input devices), and/or non-transitory computer-readable media computer media 122 (e.g., optical disks, magnetic disks) that can store code representative of the methods described herein. In addition to, or in place of processing at surface 208, processing may occur downhole.

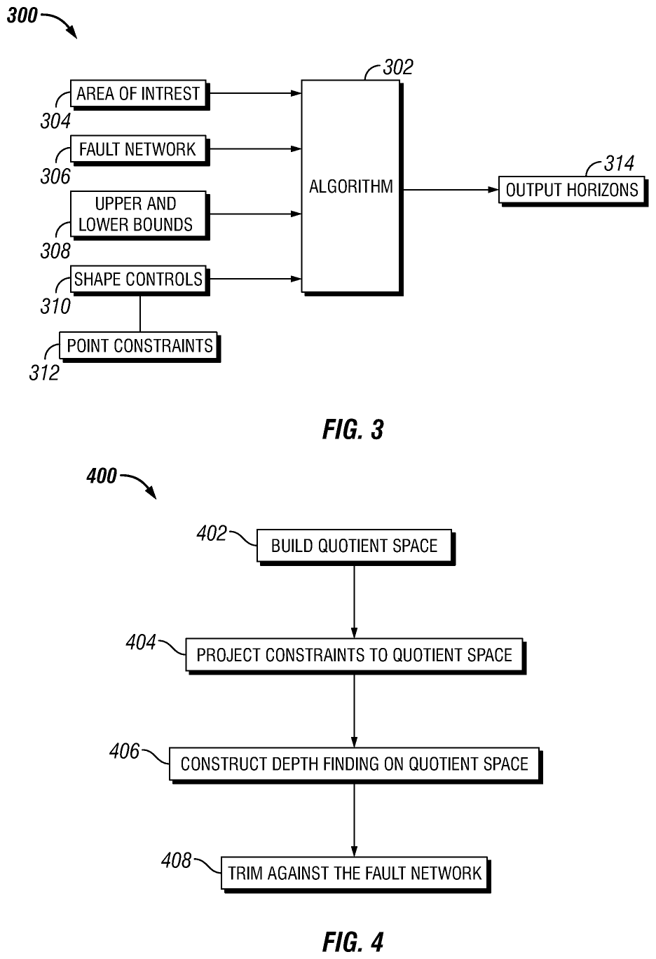

As illustrated in FIG. 3, information handling system 114 (Referring to FIG. 1 or FIG. 2) may process data to create a three-dimensional computer model of geological structures. Inputs 300 may be fed into an algorithm 302 to create a three-dimensional model of horizons 314. A horizon is a surface approximating an infinitesimally thin geologic layer, or an interface between layers in the earth. Inputs 300 may consist of an area of interest 304, a fault network 306, a set of upper and lower bounds 308, and shape controls 310. Shape controls 310 may include point constraints 312. Inputs 300 to algorithm 302 may be obtained from raw geological data that may be known to one of ordinary skill in the art. A number of operations may be applied to the raw data to obtain inputs 300 to algorithm 302. In particular, raw geological data may be expressed in an arbitrary coordinate system or transformed using a nonlinear transformation, for example to undo the effect of extreme folding and/or other deformation of the earth's crust in area of interest 304. Raw data of questionable quality may be removed. Additional data processing may be used to minimize the impact of measurement noise on the output.

A first input into information handling system 114 (referring to FIG. 1 or FIG. 2) may be area of interest 304. Area of interest 304 defines a finite two-dimensional region over which a subsurface structure, such as formation 132 (Referring to FIG. 1), is to be modeled. Area of interest 304 may be specified manually by the operator and/or be computed automatically, for example as the convex hull of the horizontal coordinates of the available data for a region and/or seismic survey.

A second input into information handling system 114 (referring to FIG. 1 or FIG. 2) may be fault network 306. Fault network 306 may be a union of surfaces in the three-dimensional space, and may be represented as a triangle mesh with no self-intersections. Such a mesh is defined as a set of triangles such that any two triangles are either disjoint and/or meet at a common edge and/or vertex. Alternatively, fault network 306 may be represented as a union of curved surfaces. The relationship of each of the output horizons 314 with fault network 306 and area of interest 304 may be summarized as follows. Each horizon is a manifold with a boundary. Its boundary points are contained in fault network 306 or correspond to the boundary of area of interest 304. Hence, each of the output horizons 314 may be described as a manifold surface terminating at fault network 306 or over the boundary of region of interest 304, or surface defined over area of interest 304 that may have discontinuities only along fault network 306.

A third input into information handling system 114 (referring to FIG. 1 or FIG. 2) may comprise a set of upper bounds and lower bounds 308. Upper and lower bounds 308 may be specified as sets of points in a three-dimensional space. Each upper and lower bound 308 is associated with a specific output horizon 314. Any of the output horizons 314 is not allowed to pass directly above any of its associated upper bounds, or directly below any of its associated lower bounds. Point A is directly above (respectively, below) a point B if A is above (below) B and the vertical line segment AB does not intersect fault network 306. Upper and lower bounds 308 may be determined automatically based on fault extensions discussed below or may be specified by an operator.

A fourth input in information handling system 114 (referring to FIG. 1 or FIG. 2) may comprise shape controls 310. Shape controls 310 provide surface modeling constraints and objectives and importance measures for each objective. Shape controls 310 may include point constraints 312. Point Constraints 312 are points in the three-dimensional space. Each point constraint is associated with a particular horizon, and each of the output horizons passes through or close to its associated data points. Shape controls 310 may also include any other modeling objectives. Examples of such modeling objectives include minimization of thickness variation of a layer between two horizons over a certain area, smoothness of the output horizons or minimum and maximum distance constraints between two horizons. Shape controls 310 may also provide importance weights of different modeling objectives that are necessary to generate a precise mathematical formula or optimization problem that determines three-dimensional model of output horizons 314.

Inputs 300 fed into algorithm 302 may be processed and produce three-dimensional models of output horizons 314. Each of the output horizons is a manifold with a boundary. As described above, the boundary points of any output horizon 314 are located either on fault network 306 or over the boundary of area of interest 304. Additionally, any vertical line segment that does not intersect fault network 306, intersects any of the output horizons 314 at no more than one point. A vertical line segment is a line segment parallel to the z-axis. The union of any of the output horizons 314 and fault network 306 splits a part of three-dimensional space enclosed by area of interest 304 into a part above the horizon and a part below the horizon. The union of sets is defined as the set that contains all elements belonging to any of these sets and no other elements.

As illustrated in FIG. 4, algorithm 302 (Referring to FIG. 3) may take inputs 300 (Referring to FIG. 3) and produce three-dimensional models of output horizons 314 (Referring to FIG. 3) through flow chart 400. Flow chart 400 may comprise building a quotient space 402, projecting constraints into the quotient space 404, construction of depth functions 406, and/or trimming against fault network 408.

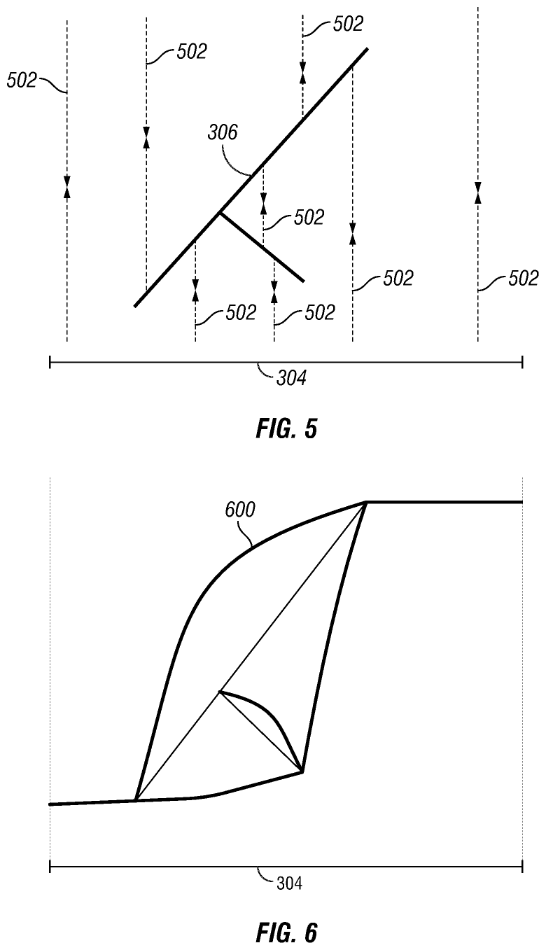

Inputs 300 (Referring to FIG. 3) may be processed to form a quotient space. Building quotient space 402 may be performed as disclosed below. A two-dimensional variant of this step is illustrated in FIGS. 5 and 6. Referring to FIG. 5, a three-dimensional space may be cut along fault network 306. Then, any vertical segment 502 that (1) is located within area of interest 304, (2) does not cross the cut and (3) starts and ends on the cut or at infinity, may be collapsed to a single point. In what follows, vertical segments satisfying these three properties are identified as maximal fault-avoiding vertical segments. Collapses preserve topology, thus, points in quotient space resulting from collapsing close segments are considered close in quotient space. It should be noted however, points of the quotient space originating from segments 502 on a different side of a fault are not considered close. In FIG. 6, the topological structure of quotient space is illustrated by line 600. In most practical cases, quotient space 600 includes several manifold pieces that may be joined together along curves. The points where quotient space 600 bifurcates in FIG. 6 are two-dimensional counterparts of these curves.

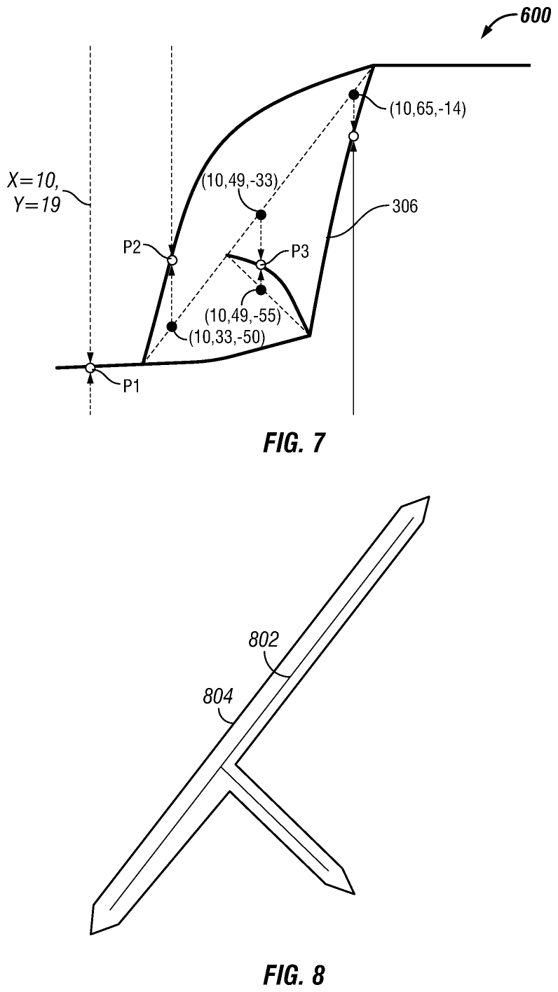

Each point P of quotient space represents vertical line segment 502 (Referring to FIG. 5) in a three-dimensional space consisting of all points that were collapsed into P during construction. All the collapsed points have identical x- and y-coordinates (x,y). Thus, each point P of quotient space has well-defined x- and y-coordinates, equal to x- and y-coordinates of any point in the three-dimensional space collapsed into P. In what follows, these x- and y-coordinates are depicted as x(P) and y(P). The z-coordinate of P is not well defined, since the points collapsed into P have different z coordinates. However, P has its associated set of z-coordinates, in this case the range extending from the minimum to the maximum z-coordinate of a point collapsed into P. P represents vertical line segment 502 including points with x- and y-coordinates equal to x- and y-coordinates associated with P and z-coordinates in the set of z-coordinates associated with P. The set of z-coordinates of P is denoted by z-set(P). These concepts are illustrated in FIG. 7, where the (x,y)-coordinates of the points P1, P2, P3 and P4 are (10,19), (10,33), (10,49) and (10,65) and their z-sets are (−∞,+∞), [−50,+∞), [−55,−33] and (−∞,−14], respectively.

Any point Q=(x,y,z) of a three-dimensional space located outside fault network 306 (Referring to FIG. 3) may be projected onto quotient space 600 (Referring to FIG. 6). The projection of Q is the point of quotient space 600 that Q was collapsed to during construction.

If the point Q=(x,y,z) is on fault network 306, the projection of Q onto quotient space 600 may not be well defined. Such a point Q may be split into several points when the space is cut along fault network 306 during building quotient space 402, and the resulting points may be collapsed to different points of quotient space 600. In order to resolve this ambiguity, fault network 306 may be considered as an infinitesimally thin volume. A closed manifold surface representing the boundary of that volume may be built as illustrated in FIG. 8, in which thin lines 802 represent fault network 306 (Referring to FIG. 4) and thick line 804 is used to show the boundary of the infinitesimally thin volume. In what follows, the boundary of the infinitesimally thin fault network volume is called boundary surface 804. Boundary surface 804 may be represented as a mesh of triangles or surface patches. For any point on boundary surface 804 the projection onto quotient space 600 is well defined. If fault network 306 (referring to FIG. 3) is represented by a triangle mesh with no self-intersections, boundary surface 804 may be constructed so that for each triangle of fault network 306 there are precisely two corresponding triangles in boundary surface 804, each of the two representing a different side of the original fault network triangle.

Once the quotient space 600 (Referring to FIG. 6) has been built, upper and lower bounds 308 and point constraints 312 (Referring to FIG. 3) are projected to the quotient space 600 (referring to FIG. 6) through project constraints to quotient space 404 (referring to FIG. 4). During this process, upper bounds and lower bounds 308 and point constraints 312 are transformed into scalar inequality or equality constraints on quotient space 600. Upper and lower bounds 308 and point constraints 312 may be specified as points in a three-dimensional space or points on boundary surface 804 (referring to FIG. 8). The transformation maps any upper or lower bound 308 or point constraint P into point (P′,z), where P′ is the result of projection of P to quotient space 600 described above and z is the z-coordinate of P.

For the step construct depth functions 406 (referring to FIG. 4), shape controls 310 (Referring to FIG. 3) and upper and lower bounds 308 (Referring to FIG. 3) are combined to construct a scalar depth function on quotient space 600 (Referring to FIG. 6) for each of the horizons. In what follows, the value of the depth function corresponding to a horizon H at a point P of the quotient space 600 is denoted by depth(H,P). At minimum, each of the depth functions is required to be continuous and to obey upper and lower bounds 308 for its respective horizon. Construct depth functions 406 may be implemented through an optimization algorithm that would minimize an objective function subject to point constraints 312 (Referring to FIG. 3). The objective function may be a weighted combination of terms provided by shape controls 310. For example, terms that promote smoothness of depth functions, decrease variation of the vertical distance between the output horizons, or keep the output surface close to point constraints 312 may be included. The constraints for the optimization problem include the inequality constraints derived from upper and lower bounds 308 through projecting constraints to quotient space 404. For any projected upper bound (P′,z) associated with a horizon H, depth(H,P′) is required to be less than or equal to z. For any projected lower bound (P′,z) associated with a horizon H, depth(H,P′) is required to be greater than or equal to z. Any number of additional constraints may be specified, as long as they do not render the optimization problem infeasible. For example, an output horizon may be forced to precisely pass through its associated point constraint P, by constraining the depth at P′ to be equal to z for the projected point constraint (P′,z). One may also add constraints on the difference of depths of different horizons, for example to impose minimum and maximum bound on thickness of the layer between two horizons, or to prevent horizons from crossing.

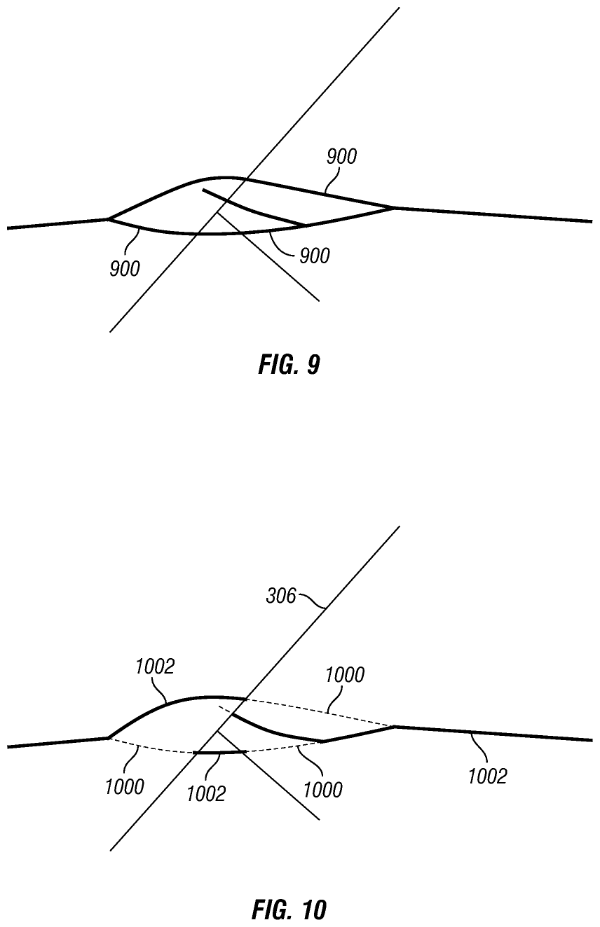

Referring to FIG. 4, trimming against fault network 408 may follow after constructing depth functions 406. For each horizon H, quotient space 600 (Referring to FIG. 6) may be embedded into the three-dimensional space by mapping a point P of the quotient space into (x(P), y(P), depth(H,P)). An example of an embedding 900 for the two-dimensional version of quotient space 600 (referring to FIG. 6) is given in FIG. 9. Note that the embedding 900 may have branching points and may have self-intersections that need to be removed to form a valid output satisfying the conditions discussed above. Trimming against fault network 408 removes images of points P of quotient space 600 such that depth(H,P) does not belong to z-set(P). In FIG. 10, parts of the embedding in FIG. 9 removed by trimming against fault network 408 are shown as dotted lines 1000. The two-dimensional counterpart of the output surface is shown as solid black line 1002.

For any horizon H, the depth function implicitly defines the continuous signed vertical distance function to the horizon, defined for all points of the three-dimensional space that do not belong to fault network 306. The signed vertical distance function may be evaluated at a point P=(x,y,z) as follows. First, P is projected to a point P′ in quotient space 600 as described above. The signed vertical distance value is defined as z-depth(H,P′); it is positive above the horizon and negative below the horizon.

The signed vertical distance function to a horizon H is also well-defined and continuous on the boundary surface 804 described above. The definition follows the steps described above. The signed vertical distance value at a point P on boundary surface 804 is z-depth(H,P′), where z is the z-coordinate of the point of fault network 306 corresponding to P and P′ is the projection of P onto quotient space 600.

The ideas described above may be implemented in a number of ways. In particular, a discretized version of quotient space 600 (Referring to FIG. 6) may be used instead of the exact version. This makes algorithm 302 (Referring to FIG. 3) easier to implement without compromising the desired properties of three-dimensional models of output horizons 314. Discretized quotient space requires base grid as an additional input into algorithm 302. Base grid may be an arbitrary two-dimensional grid, such as a triangle mesh, a polygonal mesh or a regular rectangular grid. FIGS. 3 and 4 still apply to discretized version of algorithm 302, with only one difference: base grid is an additional input to algorithm 302, in addition to area of interest 304, fault network 306, upper and lower bounds 308 and shape controls 310 (Referring to FIG. 3).

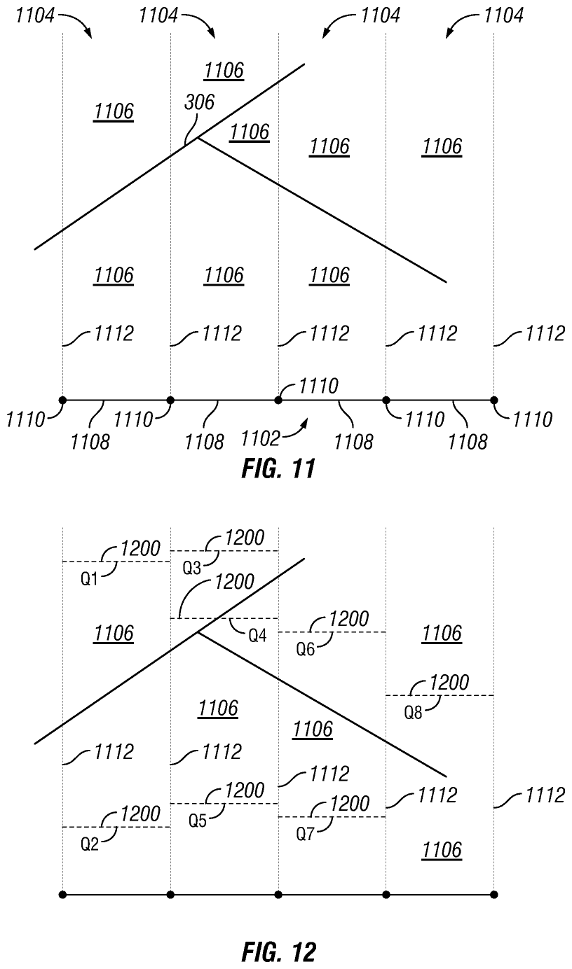

The two-dimensional variants of the key concepts behind the discretized version of quotient space are illustrated in FIG. 11. The line segments 1108 between black points 1110 are the counterparts of two-dimensional cells of the base grid 1102. Pillars 1104 are defined as two-dimensional cells of the grid extruded along the z-axis. For any given pillar 1104, volumes 1106 in pillar 1104 are defined as connected components of the complement of fault network 306 in pillar 1104. Pillar boundaries 1112 are shown as dotted lines. Volumes 1106 are pieces that result from cutting a pillar 1104 along fault network 306. While there are many possible digital representations of volumes 1106, it may be convenient to use a variant of the boundary representation for this purpose. For example, a volume V may be represented by a sub-mesh of fault network mesh that contains the boundary of V inside the interior of its pillar. Intuitively, the triangles of the sub-mesh define cuts that need to be applied to cut V out of its pillar. These triangles may also be oriented so that their normal vectors face away from V to simplify further processing.

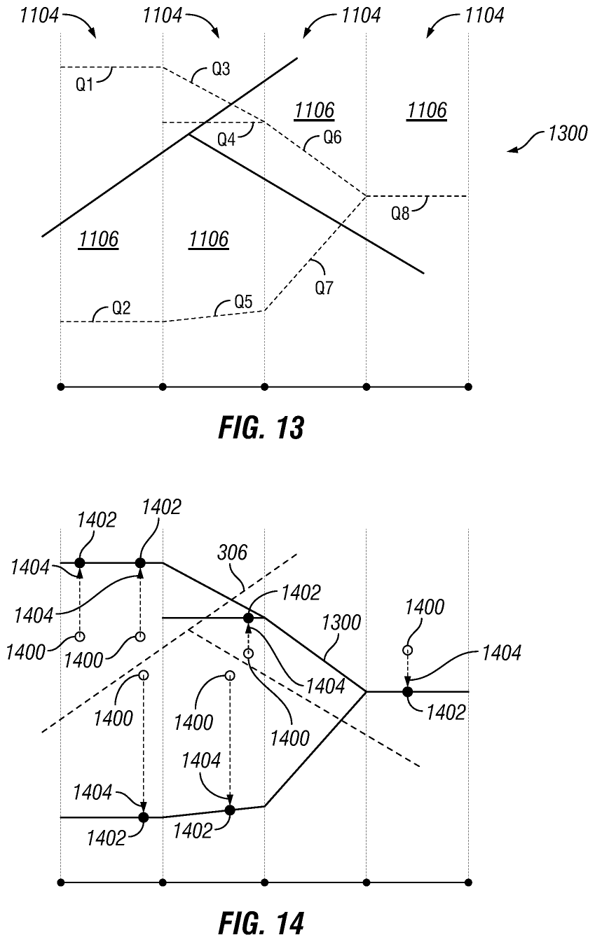

Building discretized quotient space may proceed as follows. First, all volumes 1106 in all pillars 1104 (referring to FIG. 11) are computed, as described above. Then, for any two-dimensional cell C of the base grid 1102, a copy of C is created for each volume in the pillar corresponding to C. Next, the cell copies are glued together along edges as follows. Consider two two-dimensional cells C1 and C2 of base grid 1102, meeting at an edge E, and their copies D1 and D2 representing volumes 1006 in pillars 1004 over C1 and C2 (respectively). The copies D1 and D2 are glued along the edge corresponding to E if their corresponding volumes 1106 intersect along pillar boundaries 1112. Intersections of volumes 1106 across fault network 306 are not sufficient to trigger a gluing operation. The two-dimensional counterpart of this process is illustrated in FIGS. 12 and 13. The copies of cells of the base grid corresponding to volumes are shown as horizontal line segments 1200 in FIG. 12. For illustration purposes, horizontal line segments 1200 are placed so that they are contained in their corresponding volumes if possible. The cell copy Q4 corresponds to the small triangular volume in second pillar from the left. The gluing criteria described earlier cause endpoints of the following pairs of cell copies to be identified: Q1, Q3; Q3, Q6; Q6, Q8; Q6, Q4; Q8, Q7; Q7, Q5; and Q5, Q2. For example, endpoints of cell copies Q4 and Q7 are not identified because their corresponding volumes are not adjacent along pillar boundary 1112, but Q4 and Q6 are glued because they are. Since volumes corresponding to Q4 and Q1 do not meet at all, they are not glued together. After all the gluing operations are executed, a discretized quotient space is formed, illustrated in FIG. 13 as the dashed line 1300.

Cells of the discretized quotient space are in one-to-one correspondence with the volumes 1106. Also, recall that each cell of discretized quotient space is a copy of a two-dimensional cell of a base grid 1102 (Referring to FIG. 11). Therefore, each point P of discretized quotient space 1300 has a well-defined x- and y-coordinates. If P is in a cell C of the discretized quotient space that is a copy of a cell C0 of base grid 1102, then x- and y-coordinates of P are inherited from C0.

After building a discretized variant of quotient space 402 (Referring to FIG. 4), point constraints 312 and upper and lower bounds 308 (Referring to FIG. 3) are processed by the step project constraints to quotient space 404 (Referring to FIG. 4), which may be discretized. Algorithm 302 (Referring to FIG. 3) proceeds in the following steps to find a projection of a point P=(x,y,z) onto the discretized quotient space 1300 (Referring to FIG. 13). First, pillar 1104 (Referring to FIG. 13) containing P is determined by finding two-dimensional cell of base grid 1102 containing the point (x,y). Next, the volume V containing P is found among the volumes in that pillar. This volume is denoted by V. The projection of P onto discretized quotient space 1300 belongs to cell of discretized quotient space 1300 corresponding to V, and has x- and y-coordinates equal to (x,y). FIG. 14 shows a two-dimensional example. The circles 1400 show points to be projected, the disks 1402 are resulting projected points and arrows 1404 represent projection mapping. If point P is on fault network 306, additional information may need to be specified to make projection mapping well defined. For example, point P may be specified as a point on the boundary surface 804 (referring to FIG. 8). Point constraint 312 or upper and lower bound 308 p=(x,y,z) is mapped into (P′,z) where P′ is the projection of P onto discretized quotient space 1300.

Next, the step to construct a continuous depth functions 406 (Referring to FIG. 4), whose goal is to determine a depth function on the discretized quotient space for each of the horizons, may be processed in any number of ways. For example, the depth functions may be computed by solving a quadratic programming problem defined by the shape controls 310 (referring to FIG. 3). As an objective function, one may use a combination of thin plate spline energy to promote smoothness, energy terms that decrease variation of thickness between horizons to promote conformance, or the data fit objective to keep the output horizon close to the point constraints. As constraints, one uses the upper and lower bounds 308 (Referring to FIG. 3). More precisely, for any lower bound (P′,z), mapped to the discretized quotient space 1300 as described above, and associated with horizon H the constraint depth(H,P′)>=z is added. Similarly, for any upper bound (P′,z) associated with a horizon H one adds the constraint depth(H,P′)<=z. The quadratic program may also impose minimum or maximum thickness constraints on pairs of horizons. It may also incorporate other constraints or objectives defined by the shape controls 310. A multiresolution solver may be used to find depth functions in an efficient manner. A depth function for any of the horizons may be represented by values at vertices of the discretized quotient space 1300. Values at any other point of discretized quotient space 1300 may be obtained using an interpolation scheme. For example, linear interpolation if the base mesh is a triangle mesh or bilinear interpolation if it is a regular rectangular grid.

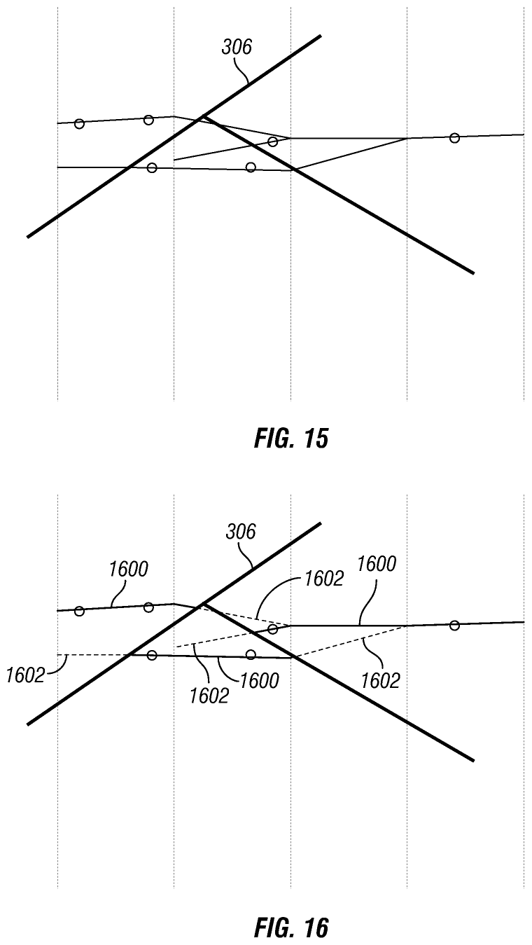

After depth functions on discretized quotient space 1300 are determined, discretized quotient space 1300 may be embedded into three-dimensional space, using the depth values as the z-coordinates for each of the horizons. A possible embedding of the discretized quotient space 1300 shown in FIG. 13 is shown as thin lines in FIG. 15. In the step trimming against the fault network 408 (Referring to FIG. 4), to trim, every cell of in the embedded discretized quotient space is interested with its corresponding volume. The result of trimming against the fault network 408 is the union of all the intersections over all cells of embedded discretized quotient space. In FIG. 16, the intersections of cells of embedded discretized quotient space that are inside their corresponding volumes are shown as thick solid black lines 1600. The part of embedding of the discretized quotient space that is trimmed away is shown as thin dashed lines 1602.

The relationship between discretized quotient space 1300 (Referring to FIG. 13) and quotients space 600 (Referring to FIG. 6) may be summarized as follows. The essential part of discretized quotient space 1300 may be obtained by collapsing subsets of vertical lines to a single point. These subsets may be defined as intersections of volumes and vertical lines. Hence, the sets of points that are collapsed to a single point when discretized quotient space 1300 is built are not maximal fault-avoiding vertical segments, but unions of maximal fault-avoiding segments that are contained in the same volume and in the same vertical line. With this interpretation, the description of the steps of the version of the algorithm based on non-discretized version of quotient space 600 apply verbatim to the version of algorithm 302 (Referring to FIG. 3) based on discretized quotient space 1300. Note that discretized quotient space 1300 built as described above may contain points that have empty z-set, but these points technically do not contribute to the output surface (all are trimmed away in trimming against fault network 408). These points are added only for convenience. One reason to add them may be to produce a more regular polygonal model of quotient space 600 (in this case, with all cells being copies of the cells of base grid 1102, referring to FIG. 11). Another reason may be to enable the user to specify constraints that may not be directly interpreted as projections of three-dimensional points to quotient space 600 when constructing depth functions as described above. For example, one may provide a user interface where the user is allowed to drag data points or constraints in a three-dimensional space, and the process may be internally interpreted as moving the points along a branch of quotient space 600 in a continuous manner. When the dragged points reach the boundary of the branch of quotient space 600, that branch may be extended by adding points with an empty z-set to accommodate such data points or constraints.

The quality of three-dimensional models of horizons 314 (Referring to FIG. 3) may be improved using fault extensions. Conceptually, fault extensions are vertical surfaces extending up from upward extension curves and down from downward extension curves. The extension curves are specified in the boundary surface 804 (Referring to FIG. 8) of the fault network 306 (Referring to FIG. 3) so that their projections to quotient space 600 (discretized or not) are well-defined. Fault extensions may split some of the volumes for the original fault network 306 into smaller ones. If the fault extensions are specified, the extended fault network, the union of the original fault network and the extensions, is used in all steps of algorithm 302 (Referring to FIG. 3), instead of the original fault network 306. Each of the horizons may use different fault extensions, and therefore quotient spaces used to construct each of the output horizons 314 (referring to FIG. 3) may be different.

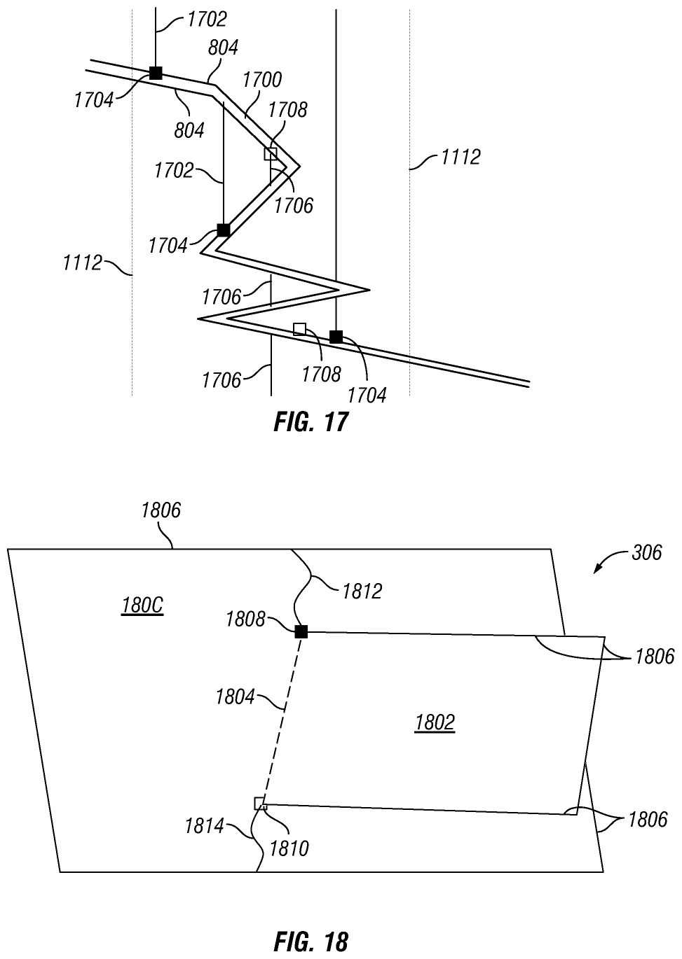

In order to make it easier to control the relationship of the output horizons 314 (Referring to FIG. 3) and the fault extensions, it may be convenient to carefully restrict the fault extensions as described below. Consider the downward extension curves. As discussed above, these curves are defined on the boundary surface 804. This means that each point of these curves may be assigned to a specific volume 1106 (Referring to FIG. 11). Split the curves into shorter segments such that each segment is contained in the same volume 1106. For each segment S contained in the volume V, intersect the union of vertical rays going down from a point in S with V. This is the contribution of S to the downward fault extensions. The union of all contributions of all segments S described above is the downward extension. Upward extensions are defined in an analogous way. The extended fault network is the union of the original fault network and downward and upward extensions described above. A two-dimensional example illustrating these concepts is shown in FIG. 17. The dotted lines represent the pillar boundaries 1112. The thick lines are boundary surface 804, with space left between lines representing one side of fault 1700 and the other for illustration purposes. Upward extensions 1702 originate from points 1704 shown as solid squares. Downward extensions 1706 originate from points 1708 shown as hollow squares. The general rule is that extension is active only inside volume containing the point it originates from. Note that these points are counterparts of extension curve segments contained in a single volume in the three-dimensional case. For point A, the extension is the entire vertical half-line extending to plus infinity. For B, the extension terminates at the first intersection of the vertical ray starting at B and extending vertically up. Thus, the extension is a single bounded line segment. Point C the extension consists of three segments, two bounded and one extending to minus infinity. These segments are intersections of the vertical ray extending down from C and the volume containing C. The extension defined by point D is empty, since the ray starting at D and extending downward leaves D's volume immediately and never enters it again. Finally, extension of E consists of a bounded and an unbounded segments

Since fault extensions are not a part of original fault network 306 (Referring to FIG. 3), one may require that they do not interact with output horizons 314. This requirement may be enforced using upper and lower bounds 308 (Referring to FIG. 3) as follows. Any point on an upward extension curve used for a horizon H may become an upper bound associated with H. Analogously, any point on a downward extension curve for a horizon H may become a lower bound associated with H. This prevents the extensions from trimming the embedded discretized quotient space 1300 (referring to FIG. 9) in the step trimming against fault network 408 (Referring to FIG. 4) of algorithm 302 (referring to FIG. 3). In practical scenarios, the set of upper and lower bounds 308 may be reduced to an equivalent finite one. For example, in the discretized variant of algorithm 302, if the base mesh is a triangle mesh, the depth function uses linear interpolation, fault network 306 is a triangle mesh, and the extension curves are polygonal lines, then it suffices to include only vertices of the extension curves and points on the extension curves that project to an edge of the base grid (under projection along z) in the set of upper and lower bounds 308. The set of upper and lower bounds 308 may also be transformed to a stronger set of constraints, that is easier to deal with or may be imposed more efficiently. For example, upper and lower bounds 308 may be transformed into box constraints, defined as constraints that involve only one variable.

Upward and downward extension curves may be defined in many possible ways. They may be specified by the user or determined automatically from a first estimate. A hybrid approach is also possible, in which the extensions are determined automatically and then edited by the users to provide them with more control over the relationship between output horizons 314 and fault network 306 (referring to FIG. 3).

Fault network limits are defined as the topological boundary of fault network 306 (Referring to FIG. 3). Fault network 306 is a union of manifold surfaces with a boundary. Fault network limit is the union of all boundaries of faults that are not contained in any other fault. If fault network 306 is represented as a triangle mesh with no self-intersections, its limit consists of all edges that have precisely one incident triangle. If the boundary surface 804 is built so that each of its triangles represents a side of a fault network triangle as described above, each limit edge of the fault network has precisely one corresponding edge in the boundary surface. In what follows, these edges of the boundary surface are referred to as limit edges. A dead end is a vertex of the boundary surface that has precisely one incident limit edge. These concepts are illustrated in FIG. 18, which shows fault network 306 consisting of two roughly rectangular faults 1800 and 1802 meeting at dashed line 1804. Thick solid black line following the boundaries of the faults is the fault network limit 1806. Note that dashed line 1804 does not belong to the fault network limit 1806: while it is contained on the boundary of the fault 1802, it is also contained in the fault 1800. The small squares 1808 and 1810 represent the two dead ends present in this fault network 306, referred to as upper dead end 1808 and lower dead end 1810.

To determine the extension curves automatically, the steps build quotient space 402, project constraints to quotient space 404 (Referring to FIG. 4) and construct depth functions on the quotient space of algorithm 302 for fault network 306 (Referring to FIG. 3) with no extensions may be utilized. The resulting depth function on quotient space 600 (Referring to FIG. 6), or discretized quotient space 1300 (referring to FIG. 13) for each horizon H is called first estimate of H. As described above, the depth function defines a signed vertical distance function from H on boundary surface 804 (Referring to FIG. 8). The upward extension curves for H may be selected from the subset of boundary surface 804 consisting of points with positive signed vertical distance values. The downward extension curves may be selected from the subset of boundary surface 804 consisting of points that have negative signed vertical distance values. This ensures that the upper and lower bounds 308 (Referring to FIG. 8) generated from the fault extensions as described above are not contradictory.

The main goal of fault extensions is to prevent leakage of the data across the faults, (i.e. prevent points on one side of the fault from having excessive influence on the shape of the surface on the other side of the fault). There are a number of possible ways to construct the upward and downward extension curves. Algorithms to build the extension curves may be based on the following design criteria. First, the points on the limit edges of boundary surface 804 (Referring to FIG. 8) that have signed vertical distance value greater than or equal to a positive user-defined threshold may be included in the set of upward extension curves. Analogously, the points on the limit edges of boundary surface 804 that have signed vertical distance value less than or equal to a negative threshold may be included in the downward extension curves. The motivation is to increase the distance between points on one side of a fault to points on the other side of the fault in discretized quotient space 1300 (Referring to FIG. 13) to reduce leakage. Second, extension curves should stay as far away as possible from points of boundary surface 804 with signed vertical distance value of zero. This is meant to prevent the lower and upper bounds 308 related to extensions, described above, from influencing the output surface's shape in a perceptible manner. Third, the union of all upward extension curves should have as few endpoints as possible, and the union of downward extension curves should have as few endpoints as possible. An endpoint of a union of curves may be defined as an endpoint of one of the curves that is not on another curve. The third criterion promotes extensions that cut all the way through a pillar 1104 (Referring to FIG. 11) (and therefore also volume 1106 they are contained in) rather than stopping in the middle of it.

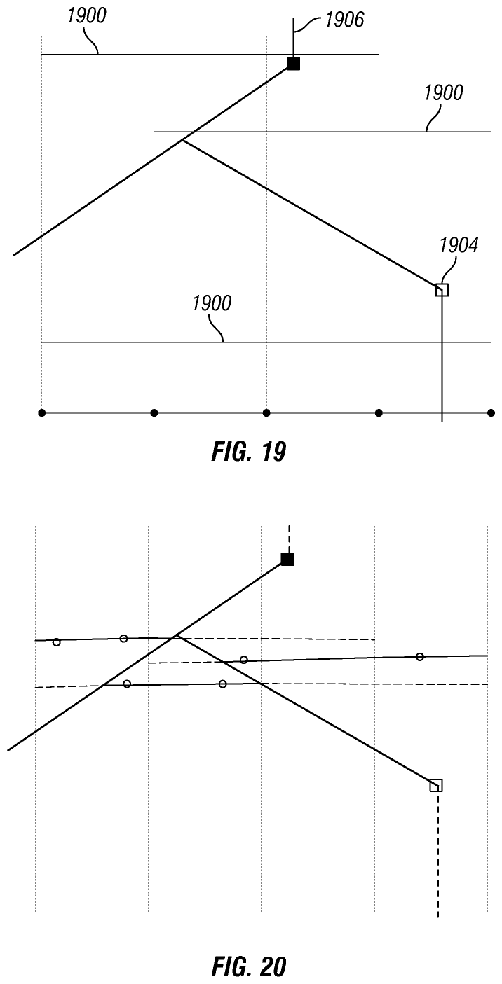

FIG. 19 shows the discretized quotient space, as dashed black lines 1900, for fault network 306 and base grid used in FIGS. 11-13, but this time with extensions, upward from the solid black square 1902 and downward from hollow square 1904. The extensions 1906 split two of the volumes that are present in FIG. 11 into two distinct volumes. They also cause the discretized quotient space to be split into three connected components. FIG. 20 shows the results for step trimming against the fault network 408 (referring to FIG. 4) applied to the fault network with extensions. Note that in this case, extensions prevent leakage that may be seen in FIG. 16.

A possible way to generate extensions in a way consistent with the design criteria described above may proceed in the following way. First, determine all points on limit edges of the boundary surface 804 consistent with the first design criterion above. These points may be used as the initial set of upward and downward extension curves. Then, determine all dead ends, on the boundary surface 804 (referring to FIG. 8), that have signed vertical distance value less than zero. These dead ends will be called lower dead ends. Similarly, determine upper dead ends, the dead ends with the signed vertical distance value greater than zero. Once the lower and upper dead ends are found, connect them to the initial downward and upward extension curves (respectively) using paths in the boundary surface 804 that are as short as possible and stay away from points of the boundary surface 804 with signed vertical distance value of zero. These paths are added to the set of downward and upward extension curves (respectively). If the fault network 306 (referring to FIG. 3) is represented as a triangle, the paths may be found using the Dijkstra's algorithm with edge weight that is proportional to the edge length but inversely proportional to the minimum absolute value of the signed vertical distance function for that edge. Edges that contain a point with signed vertical distance value of zero are not used. This edge weight promotes short paths that tend to stay far away from the first estimate. In FIG. 18, the upper dead end 1808 and lower dead ends 1810 are shown as the solid square and the hollow square, respectively. Thin wiggly curves are possible upward extension 1812 and downward extension 1814 curves found using the shortest path algorithm. They connect the dead ends to fault network limit 1806 of fault network 306.

Overall, building quotient space 402, projecting constraints to quotient space 404, and constructing depth functions on the quotient space 406 (Referring to FIG. 4) of algorithm 302 (Referring to FIG. 3) may be used to obtain first estimates for each of the horizons. For each horizon, fault extensions may be determined from its first estimate and lower and upper bounds 308 may be generated from the extension curves. Then, building quotient space 402, projecting constraints to quotient space 404, constructing depth functions on quotient space 406, and/or trimming against fault network 408 may be run with fault network 306 augmented with the fault extensions and upper and lower bounds generated from the downward and upward extension curves, as described above, to obtain the final result. Since fault extensions may be different for each horizon, the quotient space used to model each of the horizons may be different. The upper and lower bounds ensure that the output horizons do not intersect their corresponding fault extensions and therefore each of them satisfies the conditions described earlier, for fault network 306 without extensions.

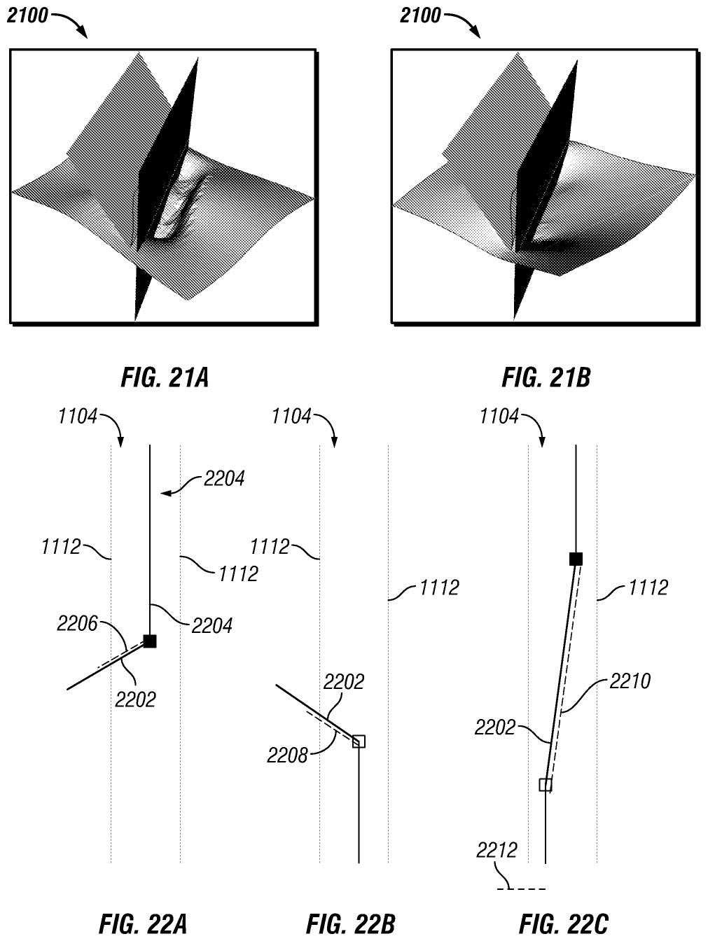

In examples, fault extensions reduce the impact of data across a fault on the result. This may dramatically improve the quality of the result. FIGS. 21a and 21b illustrate the result without and with fault extensions (respectively) for a synthetic V-shaped fault network 2100.

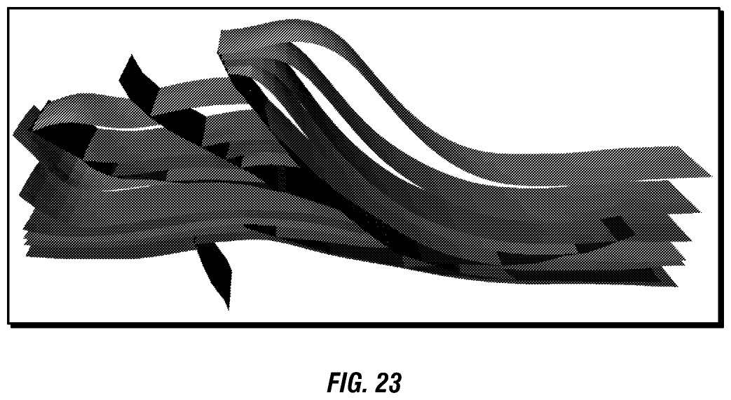

In a practical implementation, one does not necessarily have to compute an explicit representation of the extended fault network. The most important effect that extensions have is that they split some of the original volumes into smaller ones. These splits may be defined implicitly to gain the advantages provided by fault extensions in a simpler manner. An example implementation is described below. For each volume V for fault network 306 without extensions, some number of upper and lower test surfaces is specified. The volumes resulting from splitting with extensions are defined by volume code. Volume code of a point P is the binary code whose i-th entry is the parity of the number of intersections of the vertical ray starting at P with the i-th test surface. The ray extending upward is used for lower test surfaces and the ray extending downward is used for the upper test surfaces. Points that have the same volume code are considered to belong to the same volume for the extended fault network. Suitable test surfaces may be obtained by a combination of cutting the bounding surface of the volume V along the extension curves and a volume capping technique to handle test surfaces bounded by both upward and downward extension curves. Volumes obtained in this manner may not be identical to volumes obtained using explicit extensions. Examples of test surfaces in the two-dimensional setting can be found in FIG. 22(A-C). Each of the subfigures shows a pillar 1104, bounded a pillar boundary shown by the dotted vertical lines 1112, and the part of fault network 306 inside or near the pillar, identified solid black line 2202. In (a), there is an upward extension 2204 starting at the solid black square. In this case, one may use the dashed line as upper test surface 2206. That leads to different volume codes in the two volumes that exist in pillar 1104 for the extended fault network. Similarly, in (b), a lower test surface 2208 shown as the dashed line may be used to correctly define volumes for the extended fault network. In case (c), there is a connected component of fault network 306 with extensions going in opposite directions starting in that component. Upper test surface that reproduces the volumes for the extended fault network in this case may consist of the part of the fault inside the pillar 2210 and a ‘cap’ at minus infinity 2212.

In examples with several horizons, each horizon may use different fault extensions. This means that the depth functions for two surfaces S and S′ are generally defined on different quotient spaces. In order to specify conformance relation between a first discretized quotient space Q and a second discretized quotient space Q′, one may compute the multi-valued correspondence between Q and Q′. A cell C of Q is in correspondence to a cell C′ in Q′ if and only if the volume represented by C intersects the volume represented by C′, and the two volumes belong to the same pillar. This defines the multi-valued cell-to-cell correspondence. The motivation behind this particular way to determine the correspondence is to capture all possible interactions between signed vertical distances between two surfaces: intersecting volumes represent cells of the quotient spaces that may be used to evaluate the signed vertical distance from the same point in the three-dimensional space to both S and S′. The multivalued correspondence between cells may naturally be transferred to vertices. Two vertices, one in Q and one in Q′, are in correspondence if they originate from the same base grid node and have incident cells that are in correspondence. Note that one may also define the correspondence described above in a more general way. Points P of a quotient space Q and P′ of a quotient space Q′ correspond to each other if the sets of three-dimensional points collapsed to P and P′ are not disjoint.

To enforce the minimum thickness of c between two horizons H and H′, constraints of the form depth(H,V)-depth(H′,V′)>=c, or depth(H′,V′)-depth(H,V)>=c (depending on the surface order) may be utilized for every pair of corresponding vertices V and V′ of the discretized quotient spaces used to model H and H′ (respectively). Maximum thickness between two horizons can be imposed in a similar way. Squares of finite differences of the left hand sides of these constraints along the x- and y-directions may also be added to the objective function to promote preservation of thickness between surfaces linked by conformance relations.

FIG. 22 illustrates a three-dimensional geological structure containing six horizons constructed with non-crossing constraints (zero minimum thickness), and with data fit, smoothness and thickness preservation terms used as objectives.

Three-dimensional models of geological structure may be utilized to plan the location of drill sites, which may drill into formation 132 (Referring to FIG. 1). For example, drill sites that may recover the most fluid and be the most effective may be determine from the three-dimensional models of the geological structure. This may reduce cost and waste when drilling into formation 132.

This method and system may include any of the various features of the compositions, methods, and system disclosed herein, including one or more of the following statements.

Statement 1: An efficient and general method for modeling a three-dimensional geological structure, comprising: selecting input data from well measurement systems, seismic surveys or other sources; inputting the input data into an information handling system; building a quotient space; projecting constraints to the quotient space; constructing depth functions on the quotient space; trimming against a fault network; and producing a three-dimensional model of horizons.

Statement 2: The method of statement 1, wherein the input data comprises an area of interest, a fault network, upper and lower bounds and shape controls.

Statement 3: The method of statement 1 or statement 2, wherein the shape controls comprises a plurality of point constraints.

Statement 4: The method of any previous statement, wherein the producing a three-dimensional geological structure comprises a plurality of surfaces.

Statement 5: The method of any previous statement, wherein the building a quotient space comprises collapsing unions of vertical line segments that start and end at the fault network or at infinity to a single point.

Statement 6: The method of any previous statement, wherein projecting constraints to the quotient space comprises finding a union of vertical intervals collapsed to a single point of the quotient space containing a constraint point.

Statement 7: The method of any previous statement, wherein constructing depth functions on the quotient space comprises an optimization algorithm combining objectives and constraints provided by a shape controls and a constraints obtained by projecting constraints to the quotient space.

Statement 8: The method of any previous statement, wherein the trimming against the fault network comprises selecting points of the quotient space with a depth value within their z-coordinate set and mapping these points into a three-dimensional space.

Statement 9: The method of any previous statement, further comprising adding extensions to the fault network.

Statement 10: The method of any previous statement, wherein an upper and a lower bounds prevent an output surface from being trimmed by a fault extension.

Statement 11: The method of any previous statement, further comprising using correspondence between a plurality of quotient spaces from the fault network with different extensions to enforce minimum or maximum thickness constraints for a layer between two horizons.

Statement 12: The method of any previous statement, wherein the input data comprises an area of interest, a fault network, upper and lower bounds and shape controls, wherein the shape controls comprising a plurality of point constraints; wherein the building a quotient space comprises collapsing unions of vertical line segments that start and end at the fault network or at an infinite point to a single point and projecting constraints to the quotient space comprising finding a point on the quotient space from the collapsing unions of vertical line segments; wherein the constructing a smooth depth function on the quotient space comprises an optimization algorithm combining objectives; wherein the trimming against the fault network comprises selecting points of the quotient space with a depth value within a z-coordinate set and mapping the z-coordinate set in a three-dimensional space; and further comprising adding extensions to the fault network, wherein the upper and a lower bound prevent an output surface from being trimmed by a fault extension.

Statement 13: A geological modeling system for producing a three-dimensional geological structure comprising: a downhole tool, wherein the downhole tool comprises: at least one receiver; and at least one transmitter; a conveyance, wherein the conveyance is attached to the electromagnetic logging tool; and an information handling system, wherein the information handling system is configured to select an input data; build a quotient space; project constraints to the quotient space; construct depth functions on the quotient space; trim against a fault network; and produce a three-dimensional model of a geological structure.

Statement 14: The system of statement 13, wherein the input data comprises an area of interest, a fault network, upper and lower bounds and shape controls.

Statement 15: The system of statement 13 or statement 14, wherein the shape controls comprise a plurality of point constraints.

Statement 16: The system of statements 13-statement 15, wherein the produce a three-dimensional geological structure comprises a plurality of surfaces.

Statement 17: The system of statements 13-statement 16, wherein the build a quotient space comprises collapsing unions of vertical line segments that start and end at the fault network or at infinity to a single point.

Statement 18: The system of statements 13-statement 17, wherein project constraints to the quotient space comprises find a union of vertical line segments collapsed to a single point of the quotient space containing a constraint point.

Statement 19: The system of statements 13-statement 18, wherein the construction of depth functions on the quotient space comprises an optimization algorithm combining objectives and constraints provided by a shape control and constraint obtained by projecting constraints to the quotient space.

Statement 20: The system of statements 13-statement 19, wherein the trim against the fault network comprises select points of the quotient space with a depth value within a z-coordinate set and mapping these points into the three-dimensional model of a geological structure.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for modeling a three-dimensional geological structure, comprising:
selecting input data from well measurement systems, seismic surveys or other sources;
inputting the input data into an information handling system;
building a quotient space;
projecting constraints to the quotient space;
constructing depth functions on the quotient space;
trimming against a fault network; and
producing a three-dimensional model of horizons.

2. The method of claim 1, wherein the input data comprises an area of interest, upper and lower bounds, and shape controls.

3. The method of claim 2, wherein the shape controls comprises a plurality of point constraints.

4. The method of claim 1, wherein the producing a three-dimensional geological structure comprises a plurality of surfaces.

5. The method of claim 1, wherein the building a quotient space comprises collapsing unions of vertical line segments that start and end at the fault network or at infinity to a single point.

6. The method of claim 5, wherein projecting constraints to the quotient space comprises finding a union of vertical intervals collapsed to the single point of the quotient space containing a constraint point.

7. The method of claim 1, wherein constructing depth functions on the quotient space comprises an optimization algorithm combining objectives and constraints provided by shape controls and constraints obtained by projecting constraints to the quotient space.

8. The method of claim 1, wherein the trimming against the fault network comprises selecting points of the quotient space with a depth value within their z-coordinate set and mapping these points into a three-dimensional space.

9. The method of claim 1, further comprising adding extensions to the fault network.

10. The method of claim 9, wherein an upper and a lower bounds prevent an output surface from being trimmed by a fault extension.

11. The method of claim 1, further comprising using correspondence between a plurality of quotient spaces from the fault network with different extensions to enforce minimum or maximum thickness constraints for a layer between two horizons.

12. The method of claim 1, wherein the input data comprises an area of interest, upper and lower bounds and shape controls, wherein the shape controls comprising a plurality of point constraints;
wherein the building a quotient space comprises collapsing unions of vertical line segments that start and end at the fault network or at an infinite point to a single point and projecting constraints to the quotient space comprising finding a point on the quotient space from the collapsing unions of vertical line segments;
wherein the constructing a smooth depth function on the quotient space comprises an optimization algorithm combining objectives;
wherein the trimming against the fault network comprises selecting points of the quotient space with a depth value within a z-coordinate set and mapping the z-coordinate set in a three-dimensional space; and
further comprising adding extensions to the fault network, wherein the upper and lower bounds prevent an output surface from being trimmed by a fault extension.

13. A geological modeling system for producing a three-dimensional geological structure comprising:
a downhole tool, wherein the downhole tool comprises:
at least one receiver; and
at least one transmitter;
a conveyance, wherein the conveyance is attached to the downhole tool; and
an information handling system, wherein the information handling system is configured to select an input data; build a quotient space; project constraints to the quotient space; construct depth functions on the quotient space; trim against a fault network; and produce a three-dimensional model of a geological structure.

14. The geological modeling system of claim 13, wherein the input data comprises an area of interest, upper and lower bounds, and shape controls.

15. The geological modeling system of claim 14, wherein the shape controls comprise a plurality of point constraints.

16. The geological modeling system of claim 13, wherein the produce the three-dimensional model of the geological structure comprises a plurality of surfaces.

17. The geological modeling system of claim 13, wherein the build a quotient space comprises collapsing unions of vertical line segments that start and end at the fault network or at infinity to a single point.

18. The geological modeling system of claim 17, wherein the project constraints to the quotient space comprises find a union of vertical line segments collapsed to a single point of the quotient space containing a constraint point.

19. The geological modeling system of claim 13, wherein the construct depth functions on the quotient space comprises an optimization algorithm combining objectives and constraints provided by a shape control and constraint obtained by projecting constraints to the quotient space.

20. The geological modeling system of claim 13, wherein the trim against the fault network comprises select points of the quotient space with a depth value within a z-coordinate set and mapping these points into the three-dimensional model of a geological structure.

21.-35. (canceled)
